(19) United States
(12) Patent Application Publication
(10) Pub. No.: US 2003/0123539 A1
(43) Pub. Date: Jul. 3, 2003

(54) Method and apparatus for video bit-rate control

(76) Inventors: Hyung-Suk Kim, Chandler, AZ (US); Hyun Mun Kim, Scottdale, AZ (US); Tinku Acharya, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/039,462

(22) Filed: Dec. 28, 2001

(51) Int. Cl. H04N 7/12

(52) U.S. Cl. 375/240.03; 375/240.24

(57) ABSTRACT

Embodiments for implementing video bit-rate control are disclosed.

### BACKGROUND

This disclosure is related to bit-rate control for video coding

In general rate, in bit-rate control processes, such as those employed for MPEG-2 and MPEG-4, see, for example, “Test Model 5,” ISO/IEC JTC1/SC29/WG11, 1994 (hereinafter referred to as “TM5”);“MPEG-4 Video Verification Model, Version 15.0,” ISO/IEC JTC1/SC29/WG11 N3093, December 1999 (hereinafter referred to as “Q2”), the bit rate is computed based on the bits available and the last encoded frame. If the last frame is complex and uses excessive bits, more bits should be assigned to the frame to reflect its complexity. However, if there are fewer bits left for encoding, fewer bits will actually be assigned. The number of available bits or “bit budget” may depend on a number of different considerations, such as bandwidth, etc.

A weighted average reflects a compromise between accommodating complexity and meeting the “bit budget.” For example, Q2, cited previously, models the encoder rate distortion function as follows:

$$R = {X}_{1} \cdot \frac{S}{Q} + {X}_{2} \cdot \frac{S}{{Q}^{2}} , \qquad [ 1 ]$$

where

R is encoding bit count

S is encoding complexity measured by mean absolute

difference (MAD) per frame

Q is quantization parameter; and

X₁, X₂ are the modeling parameters.

The Q2 approach estimates the modeling parameters (X₁ and X₂) using the least square (LS) method based on previous encoding data. Then, the above quadratic equation is solved for Q. this method solves the LS equation based on previous encoding data, typically obtained from up to 20 previous frames. So the approach is not only complex but also typically employs a large amount of memory. Another problem with the approach, however, is that it does not always meet the desired bit rate. For example, the desired bit rate is not necessarily met for all test images recommended by the MPEG standard committee. Furthermore, experimental results show that the Q2 approach maintains the desired bit-rate by indiscriminately dropping frames. This, of course, may degrade the reconstructed video quality. A need, therefore, exists for improved bit-rate control processes.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is an image produced after being encoded with the Q2 approach; and

FIG. 2 is an image produced after being encoded using an embodiment of the claimed subject matter.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

In video image processing, control of the video bit-rate is applied to achieve a bit-rate target during encoding. Prediction mode decisions, motion vector choices and displaced frame difference (DFD) coding fidelity may affect this video bit-rate. Furthermore, once the mode and motion vectors are chosen, after motion estimation, quantization parameters (Qp) are applied, which may also affect rate control.

Several approaches for video bit-rate control have been proposed. In MPEG-4, reference software is provided by the MPEG standard committee referred to as the “Q2 algorithm” or “Q2 approach” (hereinafter “Q2”). Q2 has been employed at times as a benchmark for rate control. Likewise, the TM5 process is used in MPEG-2 reference software. These processes have disadvantages, for example, in the sense of computational complexity. Furthermore, they do not guarantee the desired bit-rate is achieved, and, hence, frames may be dropped to achieve the desired bit rate.

As is well-known, in MPEG “Generic Coding of Moving Pictures and Associated Audio Information: Video,” ISO/IEC 13818-2: International Standard 1995, there are three types of pictures or video frames: I, P, and B pictures. I pictures are intra-frame coded without reference to any other frames. The P pictures are predictive coded using previously reconstructed reference frames. The B pictures are usually coded using backward and forward reference frames and typically achieve better compression than the other types of pictures. Motion vectors are computed by a Sum-of-Absolute-Difference (SAD) based block matching scheme. A motion vector MV is represented by two components (MVx, MVy), where MVx and MVy are the motion vector components in horizontal and vertical directions, respectively.

$$SAD = {min}_{( x , y ) ∈ S} {\sum }_{j = 0}^{15} {\sum }_{i = 0}^{15} \vert C [ i , j ] - R [ {x}_{0} + x + i , {y}_{0} + y + j ] \vert , \qquad [ 2 ]$$

where

(x₀, y₀)—Upper left corner coordinates of the current macroblock

C[x, y]—Current macroblock luminance samples

R[x, y]—Reconstructed previous frame luminance samples

S—Search range: {(x, y):−16≦x, y<16}

It is noted that MPEG is provided merely as one example embodiment or application and the claimed subject matter is not limited in scope to MPEG or to any other video-related standard. However, again, typically in MPEG, the SAD values are computed for selected search points in the search space (S) depending upon the motion estimation process. The motion vector (MVx, MVy) is selected based on the displacement of the search point that results in a minimum SAD among the SAD values in the search space. The SADs provide information about the macroblocks as well as the video frames. This information may be utilized to determine the Qp for the video bit-rate control. For I pictures, the SAD with respect to the average value of its own block is employed.

One embodiment of a video bit-rate control process in accordance with the claimed subject matter provides adaptive quantization for macroblocks while maintaining the bit budget for the frame. This embodiment reduces the computational overhead using a pre-calculated SAD-rate relationship depending at least in part on Qp. Thus, computational complexity is reduced. Simulation results show that this embodiment gives better coding efficiency with better reproduced image quality due at least in part to less blocking artifacts than the Q2 rate control approach recommended in MPEG-4 video coding. Of course, the claimed subject matter is again not limited to the particular embodiment described, as shall become more clear from the following description.

In this embodiment, a quantization (mquant) method is applied that calculates the appropriate Qp value at a macroblock level depending at least in part on the macroblock SAD, while maintaining the frame bit budget using a simplified probability distribution. Video data changes occur in both spatial and temporal domains within frames. In this embodiment, therefore, adaptive quantization is applied below the frame level. Unlike a frame-level quantization method, such as, for example, Q2, mquant provides controllability inside a frame at a macroblock level, to, therefore, handle the spatially active scene.

Since SAD is generally used for motion estimation, SAD is applied here to classify input images. A relationship is estimated between the SAD of a macroblock and its associated bit-rate depending on the Qp values. In this embodiment, the bit rate is calculated for macroblocks by varying Qp within acceptable ranges. Then the rate is averaged depending on the index for the quantization step sizes. This generates a (SADᵢ, Rᵢ) relationship for the quantization parameter, where Rᵢ is the bit-rate. Next, the SAD is quantized into a number of bins (no_bin) using the equation below. The size of a bin (bin_size) is determined, in this embodiment by the total range, depending here on the picture type, divided by the number of bins (no_bin), although the claimed subject matter is not limited to necessarily employing picture type or to being employed with coding that necessarily employs different picture types.

$$\begin{matrix}index = \frac{SAD}{bin\_size} , & [ 3 ] \\ where & \\ bin\_size = \frac{range}{no\_bin} & \end{matrix}$$

In this example, no_bin=8. So there are 8 classes of macroblocks for each I, P and B pictures. Next, the SAD and bit-rate relationship is tabulated for the Qp values depending on the picture types, again, for this particular embodiment. In the encoder, the index for a macroblock is calculated using the equation above and pre-calculated SAD, that is, in this embodiment, the SAD obtained from motion estimation. After calculating this index, a Qp value is determined that meets the given or desired bit-rate for the current frame, as explained in more detail hereinafter.

For a frame, extreme Qp values are employed initially. Using these values, the bits for the macroblocks in the frame are added using the index (quantized SAD) and Qp value from look-up tables. If the added bits are still less than the desired bit rate, this process is repeated by decreasing the Qp value until the sum is greater than the given budget.

For this embodiment or example, Qp_max=20 for I,P pictures and 28 for B pictures, and Qp_min=3 for I,P pictures and 8 for B pictures. These values are chosen to keep the image quality of reference images (I and P-pictures, in this embodiment) and provide a higher compression for B-pictures.

begin

for (l=Qp_max; l>= Qp_min; l--){

sum_rate = 0;
for (i=0; i<N; i++){

for (j=0; j<M; j++){

| | |
|---|---|
| sum_rate | = |

sum_rate+RATE[index][l];

}

}
if(sum_rate>budget) break;

}
Qp = l; /* your desired Qp for current frame */

end

where

N: image height divided by 16

M: image width divided by 16 (N×M represents number of macroblocks per frame)

sum_rate: represents the estimated bits spent using the index and Qp relationship

Budget: allocated bits for the current frame.

Once the Qp value for a frame is determined, for an MPEG-4 implementation, although, of course, the claimed subject matter is not limited in scope in this respect, the Qp value is adjusted macroblock-wise. To implement this feature effectively, the macroblocks are divided into three groups based on their activity measured by a macroblock's SAD. Different Qp values are then applied to the macroblocks depending on the groups they belong to; however, the overall Qp for the frame should be the one previously determined. A potential strategy to implement such an approach is to apply a higher Qp to a higher SAD class, as described in more detail below. However, alternate strategies may also be applied.

A strategy in which a higher Qp is applied to a higher SAD class, denoted here as “SAD+mq,” is designed to maintain the desired bit budget. This approach may, therefore, reduce the amount of bits generated for a highly active macroblock. On the contrary, a strategy in which a lower Qp is applied for a higher SAD class, denoted here as “SAD−mq,” may maintain the quality of video more successfully. This approach may allot more bits to the macroblocks containing higher activity.

To determine the Qp to assign to a specific macroblock, the number of occurrences for each bin, sad_count, may be counted. This permits calculation of threshold values that partition the macroblocks in the currently coded frame into three groups, while maintaining the desired bit budget. These thresholds divide the macroblocks into groups of roughly equal probability to produce a cumulative distribution. Therefore, specific Qp values may be assigned so that the overall Qp of the frame, as previously determined, allows the bit budget to be maintained.

The number of occurrences for each SAD bin is counted to find the previously described thresholds, and, then assign bits for the macroblocks. For P and B pictures, the SAD of the macroblocks is calculated in MPEG during the motion estimation. Additional complexity, however, is present for 1 pictures. Its SAD is calculated because one is not calculated for such pictures during motion estimation. Once the rate is determined, the SAD are quantized by division.

This embodiment implemented in C code is as follows:

begin

th1 = budget /3;
th2 = 2*th1;
temp = 0;
for (i=0; i<N_BIN; i++) {
temp = temp + sad_count[i]*rate[index][Qp];

if (temp > th1) {

th1= i;
break;

}

}
temp = 0;
for (i=0; i<N_BIN; i++) {
temp = temp + sad_count[i] *
rate[index][Qp];

if (temp > th2) {

th2= i;
break;

}

}
k = 0;
for (i=0; i<vop->height/16; i++){

for (j=0; j<vop->width/16; j++){

if(sad[i][j]<=th1)

qp[k] = qp[k]+1;

else if(sad[i][j]>=th2) qp[k] =

qp[k]-1;

k++;

}

}

end.

The Qp value to assign to a specific macroblock is accomplished in this embodiment using dquant, which is defined as follows:

dquant=Qp(current MB)−Qp(previous MB)

For this embodiment, an acceptable range of dquant is ±2 although, again, the claimed subject matter is not limited in scope in this respect. Once a desired Qp for the frame is obtained, the Qp value is perturbed ±1 so that the maximum change will be ±2. However, the Qp value for the macroblocks is adjusted based on the thresholds previously determined.

In summary, for this embodiment, once the Qp value is determined for the frame, the Qp value for specific macroblocks is adjusted based at least in part on the SAD for the macroblock. However, the Qp value adjustment at the macroblock level is conducted so that the overall Qp value for the frame is maintained, where one-third are adjusted up and one-third are adjusted down; however, which third is adjusted up and which third is adjusted down depends on the strategy being pursued as previously discussed. Furthermore, the adjustment is conducted so that the acceptable range for dquant is maintained, as previously described.

By contrast, Q2 estimates the modeling parameters using least square (LS) method based on previous encoding data, as previously described, The following equation (Eq. [5]) is solved:

Y=AX [symbol] X=(A^{T}A)⁻¹A^{T}Y,

where

A^{T} matrix transpose of A

After obtaining solutions of the above Eq. [5], the quadratic equation (Eq. [1]) is solved with respect to Q. Solving the LS equation involves a matrix inverse calculation based on previous encoding data, up to in many cases as much as 20 previous frames. Therefore, computational complexity, as well as memory utilization, may be significant.

Table 1, therefore, compares the performance between Q2 and the previously described embodiment. Experiments were performed using 2 video sequences. The experimental results may be summarized as follows:

The embodiment described maintains the desired bit budget closely with better compression efficiency while the Q2 bit-rate approach may drop frames, as shown in Table 1.

Also, Q2 often yields over bit-budget compared to the desired budget, as shown in Table 1. The previously described embodiment yields bit-budgets close to the desired one.

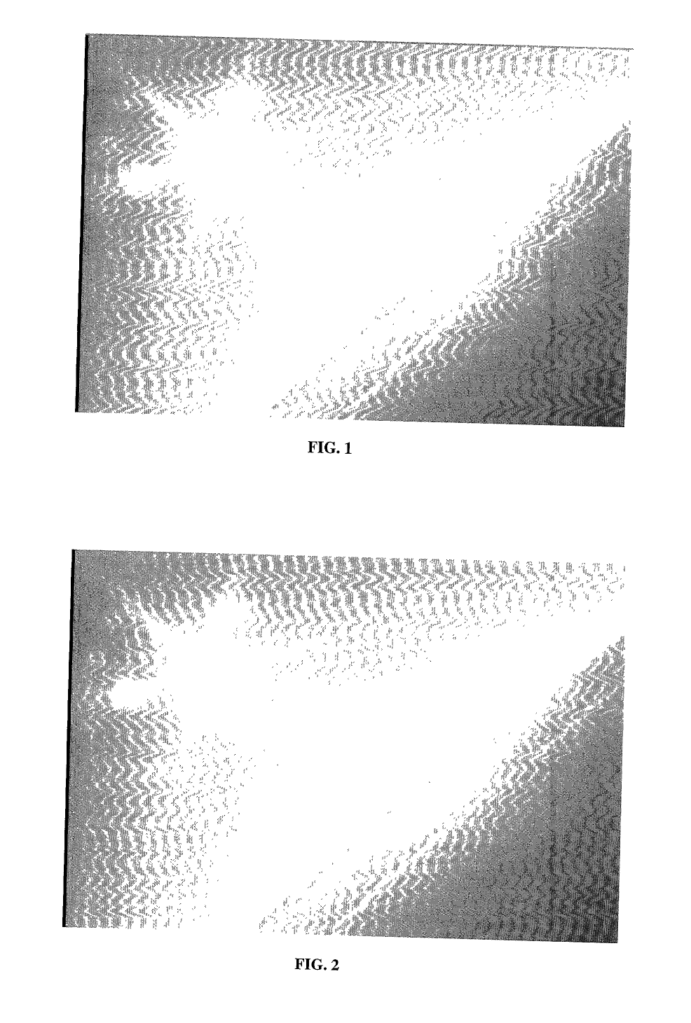

PSNR results of the previously described embodiment are comparable to Q2; however, less blocking artifacts result from the previously described embodiment, as shown in FIGS. 1 & 2.

TABLE 1

| | Q2 | | SAD − |
|---|---|---|---|
| | Rate control | SAD + mq | mq |
| Firebird (fast motion) | | | |
| Bits/Frame | 34405 | 32898 | 32922 |
| (desired bits/frame = 32768) | | | |
| Number of Frames dropped | 70 out of 200 | NONE | NONE |
| | original frames | | |
| Silent voice (moderate | | | |
| motion) | | | |
| Bits/Frame | 18565 | 17396 | 17484 |
| (desired bits/frame = 17476) | | | |
| Number of Frames dropped | 0 | 0 | 0 |

The embodiment described, therefore, provides several improvements compared to state-of-the-art methodologies, such as Q2. Some of these improvements may include:

Utilizing the SAD computation involved in motion estimation.

Improved adherence to target bit rate.

Compression efficiency.

Flexibility, reflected in the alternate quantization step size assignment strategies presented

Reducing blocking artifacts, as shown in FIGS. 1 and 2.

Computationally efficiency and reduced complexity, compared to Q2, in particular.

Suitability for low-power applications and implementations.

Adaptable to include picture level rate control.

It will, of course, be understood that, although particular embodiments have just been described, the claimed subject matter is not limited in scope to a particular embodiment or implementation. For example, one embodiment may be in hardware, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, or a computing system, for example, may result in an embodiment of a method in accordance with the claimed subject matter being executed, such as an embodiment of a method of implementing video bit rate control, for example, as previously described. For example, an image processing platform or an image processing system may include an image processing unit, an image input/output device and/or memory.

While certain features of the claimed subject matter have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. A method of implementing video bit-rate control comprising:
applying different quantization step-sizes to different portions of a frame being encoded.

2. The method of claim 1, wherein the different portions of the frame comprise contiguous, nonoverlapping, equally sized portions.

3. The method of claim 1, wherein the quantization step-sizes are chosen based, at least in part, on the amount of variation in the pixel values of the particular portions of the frame.

4. The method of claim 3, wherein a measure of the variation in pixel values of the particular portions of the frame comprises sum of absolute differences (SAD).

5. The method of claim 3, wherein the quantization step-sizes are further chosen to substantially maintain a predetermined “bit budget.”

6. A method of implementing video bit-rate control comprising:
selecting an acceptable quantization parameter for a frame;
selecting quantization parameters for portions of the frame based, at least in part, on the variation in pixel values of the particular portions of the frame; and
adjusting the quantization parameters of the portions of the frame so as to achieve the acceptable quantization parameter for the frame.

7. The method of claim 6, wherein the quantization parameters of the portions of the frame are adjusted independently.

8. The method of claim 6, wherein the portions of the frame comprise contiguous, nonoverlapping, substantially equally sized portions.

9. The method of claim 8, wherein the portions comprise microblocks.

10. The method of claim 6, wherein the variation in pixel values of the particular portions of the frame is measured based, at least in part, on the sum of absolute differences (SAD).

11. The method of claim 6, wherein the acceptable quantization parameter for the frame is selected, based at least in part, on the variation in pixel values over the frame.

12. The method of claim 11, wherein the variation in pixel values over the frame is measured, at least in part, based on the sum of absolute differences (SAD).

13. An article comprising: a storage medium, said storage medium having stored thereon instructions, that, when executed result in:
applying different quantization step-sizes to different portions of a frame being encoded.

14. The article of claim 13, wherein the instructions, when executed, apply the different quantization step-sizes to different portions of a frame, the different portions comprising contiguous, nonoverlapping, substantially equally sized portions.

15. The article of claim 14, wherein the instructions, when executed, apply the different quantization step-sizes to different portions of a frame, the different portions comprising macroblocks.

16. The article of claim 13, wherein the instructions, when executed, result in the quantization step-sizes being chosen based, at least in part, on the amount of variation in the pixel values of the particular portions of the frame.

17. The article of claim 16, wherein the instructions, when executed, measure the variation in pixel values of the particular portions of the frame based, at least in part, on the sum of absolute differences (SAD).

18. The article of claim 17, wherein the instructions, when executed, result the quantization step-sizes being further chosen to substantially maintain a predetermined “bit budget.”

19. An article comprising: a storage medium, having stored thereon instructions that, when executed implement video bit-rate control by:
selecting an acceptable quantization parameter for a frame;
selecting quantization parameters for portions of the frame based, at least in part, on the variation in pixel values of the particular portions of the frame; and
adjusting the quantization parameters of the portions of the frame so as to achieve the acceptable quantization parameter for the frame.

20. The article of claim 19, wherein the instructions, when executed, further result in the quantization parameters of the portions of the frame being adjusted independently.

21. The article of claim 19, wherein the instructions, when executed, further result in the variation in pixel values of the particular portions of the frame being measured based, at least in part, on the sum of absolute differences (SAD).

22. The article of claim 19, wherein the instructions, when executed, further result in the acceptable quantization parameter for the frame being selected, based at least in part, on the variation in pixel values over the frame.

23. The article of claim 22, wherein the instructions, when executed, further result in the variation in pixel values over the frame being measured, at least in part, based on the sum of absolute differences (SAD).
